(19) United States
(12) Patent Application Publication
(10) Pub. No.: US 2021/0163137 A1
(43) Pub. Date: Jun. 3, 2021

(54) DEVICE FOR THE EMERGENCY MANUAL CONTROL OF A REMOTE SYSTEM

(71) Applicant: LACE, Saint-Maur (FR)

(72) Inventors: PAUL LACHEVRE, Rivarennes (FR); PATRICK MAINGUIN, Argenton sur Creuse (FR)

(21) Appl. No.: 16/770,601

(22) PCT Filed: Dec. 3, 2018
(86) PCT No.: PCT/EP2018/083352

§ 371 Date: Jun. 7, 2020

(30) Foreign Application Priority Data
Dec. 7, 2017 (FR) 1761791

(51) Int. Cl. B64D 1/22; B66C 1/34

(52) U.S. Cl. CPC B64D 1/22; B64C 27/04; B66C 1/34

(57) ABSTRACT

The invention relates to a device (1) for the emergency manual control of a remote system, said device comprising: a body (2); a manual actuator (3); a system for transmitting a movement of the manual actuator (3) to the remote system; and a security element that limits the possibilities for an operator to actuate said manual actuator. Said manual actuator (3) comprises a keeper (300) and the security element is a latch (4) that can be rotated about a latch axis (A2) of the body and comprises a notch (40) that can cooperate with the keeper (300).

### CROSS REFERENCE TO RELATED APPLICATIONS

This application is a National Stage of International Application No. PCT/EP2018/083352, filed Dec. 3, 2018, which claims priority from FR 1761791 filed Dec. 7, 2017, the entire contents of which are incorporated herein by reference.

### TECHNICAL FIELD

The invention belongs to the field of mechanical emergency controls on an aircraft.

More particularly, the invention relates to the field of external load transport by an aircraft.

More particularly, the invention relates to the field of releasing an external load carried by an aerial lift system.

More particularly, the invention relates to a manually controlled device for releasing a load carried by a cargo hook.

### STATE OF THE ART

Some aircraft are equipped with cargo hooks for the transport of an external load. Such hooks are associated with systems for releasing loads in emergency situations.

French patent FR 2 670 460 discloses a helicopter rope installation enabling the release of ropes. The installation consists of a beam fixed to a floor of the helicopter. The beam is capable of receiving a set of latches capable of retaining a rope by means of a keeper. A lever is associated with each latch in order to release the rope by actuating said lever, causing a rotation of a keeper and releasing the rope.

A disadvantage of this installation is that there is only an action to be carried out in order to release a rope, which is not in agreement with the latest regulations. A manipulation error can release the rope and trigger an incident.

FIG. 1 illustrates another known manual release device. This device has a body 2, a manual actuator 3 comprising a handle 31 and a lever 30 and a locking system 4 consisting of a safety wire preventing the actuation of the lever. The safety wire of the locking system 4 must be broken by an operator in order to be able to actuate the handle 31 and thus release the load.

Such a device requires two actions to release the load: breaking the safety wire and actuating the lever. However, these two actions are not well distinct, and in some cases the load can be released in a single action when the lever is actuated.

### SUMMARY OF THE INVENTION

The invention proposes a solution to the disadvantages of the prior art. The device according to the invention proposes a double lock making it possible to limit handling errors relative to the solutions of the prior art, the two unlocking actions being well distinct from each other. The proposed solution is thus compliant with the new requirements of aeronautical regulations requiring two different actions to be carried out by an operator in order to allow the release of a load.

Furthermore, the proposed solution enables the release of a load using a single finger, the left hand or the right hand indifferently.

The invention relates to a device for manual emergency control of a remote system.

The device comprises:
a body;
a manual actuator;
a system for transmitting motion from the manual actuator to the remote system and;
a safety element limiting the possibilities for an operator to actuate said manual actuator;
   More particularly, in the device according to the invention:
the manual actuator comprises a keeper;
the safety element is a latch capable of being rotated about a latch axis of the body and including a notch capable of cooperating with the keeper.

In one embodiment, the manual actuator includes a lever and a handle integral with each other, the keeper being disposed on the lever proximate the latch.

In one embodiment, the latch comprises at least one tension spring, a first end of said tension spring being fixed to the body at a fastening point, and a second end of said tension spring, opposite the first end, being connected to the latch at an attachment point offset from the latch axis.

In one embodiment, the latch comprises at least one gripping means allowing an operator to rotate said latch.

In one embodiment, the latching system further comprises at least one stop for blocking rotation of the latch in a locking direction or an unlocking direction of the device.

In one embodiment, the transmission system further comprises:
a hydraulic control block;
a piston rod connecting the manual actuator to said hydraulic control block and capable of being moved by movement of the manual actuator in order to act on said hydraulic control block.

In one embodiment, the body comprises two lateral flanges made integral with one another by a set of spacers.

In one embodiment, the remote system is a hook for releasing a load suspended from a sling.

The invention also relates to an assembly comprising an aircraft and a device for manual emergency control of a remote system according to the invention, said device being attached to a structure of the aircraft.

In one embodiment, the aircraft is a helicopter.

### BRIEF DESCRIPTION OF THE FIGURES

The invention will be better understood upon reading the following description and examining the accompanying figures. These are presented only by way of non-limiting indication of the invention.

In the figures, elements performing identical functions carry identical reference numbers.

FIG. 1, already cited, represents an emergency device with manual control of the prior art.

FIG. 2 shows an isometric view of the device according to the invention in a particular embodiment.

FIG. 3 shows a top plan view of the device according to the invention in the embodiment of FIG. 2, in the absence of the hydraulic block.

FIG. 4A shows a side view of the device according to the invention in the embodiment of FIG. 2, in the locked position.

FIG. 4B represents a side view of the device according to the invention in the embodiment of FIG. 2 in the unlocked position, and lever in the low position.

FIG. 4C shows a side view of the device according to the invention in the embodiment of FIG. 2, with a latching system in the unlocked position, and a lever in the high position.

FIG. 5 shows an isometric view of the latch, the tension spring and the support spacer in the embodiment of FIG. 2, the latch being in the lowered position.

FIG. 6 is a schematic block diagram of an aircraft, control, hook, and sling.

The figures are schematic diagrams proposed for a good understanding of the invention and are not necessarily scaled.

### DETAILED DESCRIPTION

In the example detailed below, the invention relates to an emergency device 1 with manual control of release of a load carried by aerial lift, for example by a load hook of a helicopter.

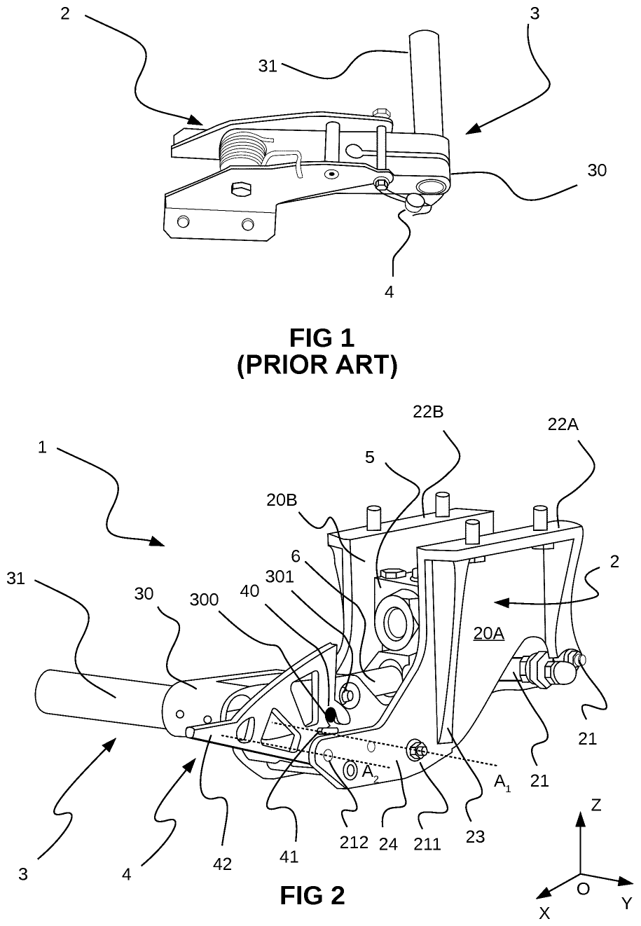

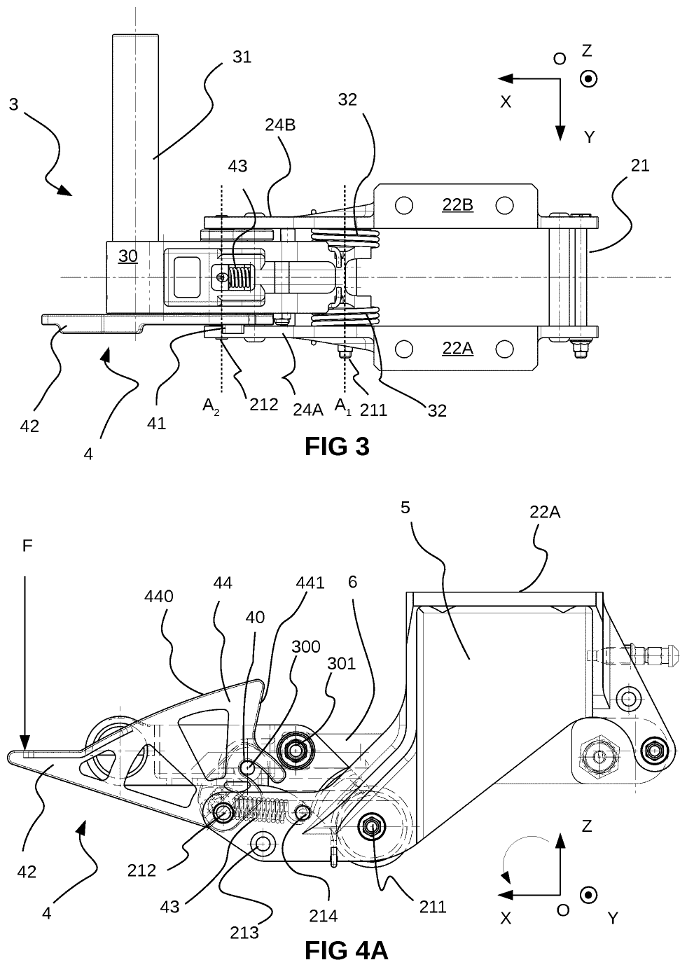

With reference to FIGS. 2 and 3, the device 1 according to the invention comprises:
a body 2;
a manual actuator 3;
a latch 4;
a hydraulic control block 5;
a piston 6.

For the sake of simplification of the description, an orthonormal coordinate system (O, X, Y, Z) is defined. The plane (OXZ) is parallel to an average plane of symmetry of the body. The axis (OY) is perpendicular to this plane.

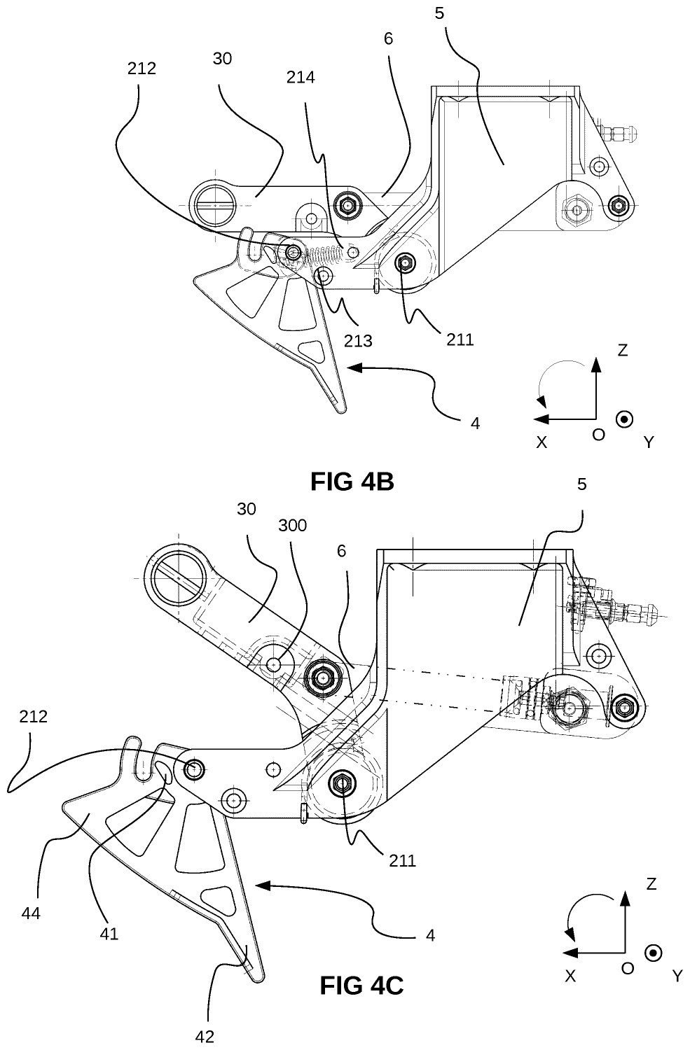

With reference to this orthonormal coordinate system, a direction of direct rotation about the axis (OY) is that indicated by the arrow in the vicinity of the mark in FIGS. 4A-4C. A direction of indirect rotation is by definition a direction of rotation that is opposite to the direction of direct rotation. With this convention, a rotation of 90° of the axis (OZ) in the direct direction about the axis (OY) transforms the axis (OZ) into the axis (OX).

The body 2 comprises two lateral flanges 20A, 20B arranged opposite, substantially parallel to one another, and made integral with one another by a plurality of spacers 21.

Each of the lateral flanges 20A, 20B is extended at an upper end by a plate 22A, 22B substantially perpendicular to an average plane of said flange. The plate 22A, 22B has a set of holes capable of receiving fasteners, making it possible to fix the device 1 to a structure of an aircraft 500. At least one rib 23 is arranged on an outer face of each lateral flange in order to provide rigidity to said flange and to the associated plate 22A, 22B.

The manual actuator 3 comprises a lever 30 and a handle 31 fixed to said lever.

The lever 30 is traversed at a first end by a first spacer 211 oriented parallel to the axis (OY) along a first axis of lever A1 and arranged between the side flanges 20A, 20B of the body 2 at arms 24A, 24B of said flanges. The lever 30 can be rotated about said first spacer. Two helical springs 32 are arranged around the first spacer 211, on either side of the first end of the lever 30, as illustrated in FIG. 3. These springs 32 are connected at one end to the arms 24A, 24B of the lateral flanges 20A, 20B and by another end to the first end of the lever 30, so that these springs oppose the rotation of the lever 30 when the device 1 is implemented.

A protuberance situated on a flank of the lever 30 situated in the vicinity of the latch 4 extends perpendicularly to the said flank in order to form a keeper 300.

The handle 31 is fixed to a second end of the lever 30, opposite the first end of said lever. The handle 31 is secured to the lever 30 by any suitable fastening means, for example by engagement and clamping in a bore of said handle.

The latch 4 is formed in a substantially planar part, mounted in rotation relative to the flanges 20A, 20B about a second spacer 212 oriented parallel to the axis (OY) along a latch axis A2, at a first end of said lock arranged between said flanges of the body 2, so that the latch 4 can be rotated about the latch axis A2 of said second spacer.

The latch 4 has in the vicinity of its first end a notch 40 arranged in the plane of said latch. The notch 40 is formed by a circular arc groove centered on the latch axis A2. The notch 40 is capable of interacting with the keeper 300 of the lever 30, the keeper 300 being capable of sliding in the notch 40 when the latch 4 is in rotation, and being capable of blocking the rotation of said latch when said keeper is engaged in the notch 40.

A relief stop 41, extending perpendicularly to an average plane of the latch 4 and in the same direction as the keeper 300 relative to the mean plane of the lever 30, limits the rotation of the latch, in an indirect direction, about the axis (OY), by resting on the arm 24A of the corresponding flange 20A. The locking in rotation of the latch 4 in an indirect direction about the axis (OY) is therefore ensured by the keeper 300 and the stop 41. The presence of the stop 41 makes it possible to reduce the forces experienced by the keeper 300 during the blocking, by allowing a distribution of the forces between these two elements, thus avoiding deterioration of the keeper 300 that can lead to safety problems.

The first end of the latch 4 defines a first gripping means 44, of generally triangular shape, allowing an operator to rotate the latch 4 about the latch axis A2, depending on whether it presses on an upper surface 440 of the gripping means 44 to engage the notch 40 on the keeper 300, or it presses on a lateral surface 441 to disengage the keeper 300 from the notch 40.

The latch 4 has at a second end a second gripping means in the form of a latch lever 42, on which an operator can also act to rotate said latch about the latch axis A2 by exerting pressure on said latch lever.

The shape of the latch 4 is thus ergonomic, since it allows an operator to maneuver the latch 4 either from the left hand or from the right hand depending on the gripping means gripped by the operator.

Preferably, the latch 4 comprises recessed areas in order to limit its mass.

When the keeper 300 is engaged in the notch 40, the rotation of the lever 30 is blocked; the manual actuator 3 is locked.

When the notch 40 tilts and releases the keeper 300 following an action of the operator on the latch 4, the rotation of the lever 30 is possible; the manual actuator 3 is then unlocked.

The hydraulic control unit 5 is arranged between the flanges 20A, 20B of the body 2. The hydraulic control block 5 controls an opening of the aerial lift system for the release of the load carried by said lifting system. The hydraulic control unit 5 comprises in particular a reservoir for a fluid, for example oil, connected to a master cylinder (not shown).

A piston rod 6 couples the hydraulic control block 5 to the lever 30. The piston rod 6 is connected at a first end to a piston spacer 301 extending between the flanks of said lever, perpendicularly to said flanks. The piston rod 6 is connected at a second end to the master cylinder of the hydraulic control block 5.

The relative organization of the different elements and their functions are specified in the context of the implementation of the device described below.

With reference to FIGS. 4A-4C illustrating this implementation, it is recalled that the direction of direct rotation about the axis (OY) is that indicated by the arrow in the vicinity of the mark. The indirect direction therefore corresponds to the opposite direction of rotation.

With reference to FIG. 4A, the device is in the locked position. In this position, the keeper 300 is engaged in the notch 40 of the latch 4, the position of which is limited by the stop 41 bearing on the arm 24A. In this locked position, the latch 4 is locked in rotation and the latch lever 42 is in a raised position, taking into account the shape of the latch 4.

With reference to FIGS. 4A and 4B, an operator unlocks the system by disengaging the catch 40 by applying a force F for example to the latch lever 42 in order to pivot the latch 4 in the forward direction about the latch axis A2. With reference to the figures, the force F is directed downwards, that is to say in the direction of decreasing dimensions Z, and the unlocking of the lever 3 is obtained when the keeper 300 is completely disengaged from the notch 40.

The pivoting of the latch 4 is possible until said latch comes into contact with a stop spacer 213 forming a stop of the body 2. The latch 4 is then in the lowered position.

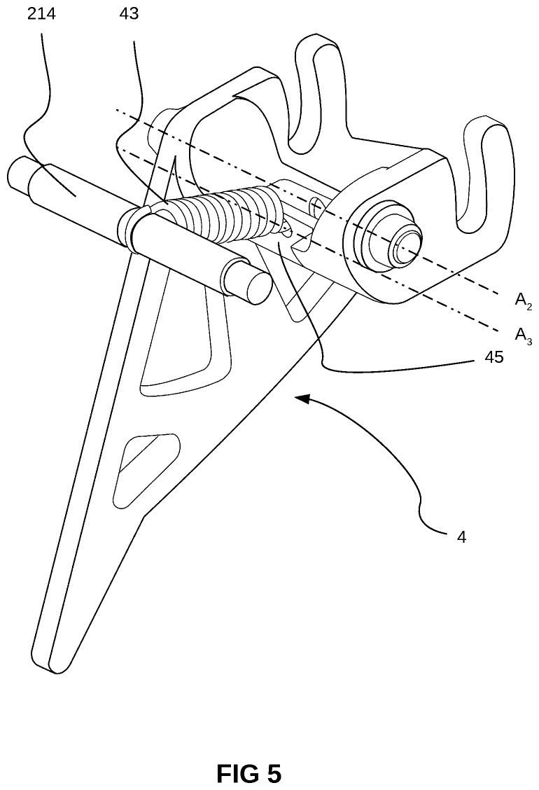

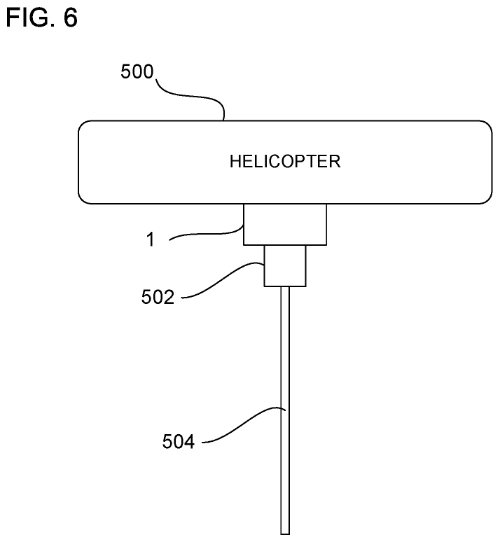

A tension spring 43 connects the latch 4 to a support spacer 214 of the body 2. A first end of the tension spring 43 is fixed to the spacer 214, and a second end of the spring is fixed to the latch 4. With reference to FIG. 5, the latch 4 comprises a transverse part 45 comprising a hole into which the second end of the tension spring 43 is inserted. The transverse portion extends along an average axis A3 offset from the latch axis A2.

With reference to FIG. 4A, when the latch 4 is in the raised position, the point of attachment of the tension spring 43 opposite the support spacer 214 is above the latch axis A2, causing a return force opposing an unlocking. A sufficient force is therefore necessary on the one hand of an operator to counterbalance this return force when the device is unlocked.

With reference to FIG. 4B, when the latch 4 is in the lowered position, the point of attachment of the spring 43 is below the latch axis A2, thus opposing a rotation of the latch 4 towards the raised position, thereby promoting unlocking.

A clearance angle between an intermediate position and either the lowered position or the raised position of the latch 4 must be sufficient to allow the pull spring 43 to pull the latch 4 either to the raised position or to the lowered position. In the illustrated example, the limit rotation angle beyond which the tension spring 43 becomes favorable for locking or unlocking is about 30°.

In a variant, not shown, the device comprises at least two tension springs arranged in parallel. This arrangement makes it possible to adapt the locking and unlocking force according to the need.

FIG. 4B illustrates the device in a position in which said device is unlocked, and the lever 30 is in the low position corresponding to a trigger waiting position. In this configuration of the device 1, the lever 30 is released and held in its initial position. The lifting system always carries the load.

With reference to FIG. 4C, once the device 1 is unlocked, the operator exerts on the handle 31 of the manual actuator 3 a force directed substantially along the increasing dimensions Z, which manual actuator 3 is, after unlocking, capable of being rotated.

The rotation of the lever 30 drives a movement of the piston rod 6, which allows the introduction of the fluid from the hydraulic control block 5 into the master cylinder, subsequently driving the unlocking of the hook 502 of the lifting system connected to the device according to the invention via the hydraulic control block 5 controlling its opening, and the release of the sling 504 and load.

In FIG. 4C, the lever 30 is said to be in a high-position position or a trigger position.

The device 1 can of course be subsequently reset in the locked position, by lowering the lever 30 in the low position by virtue of the handle 31, and then by rotating the latch 4 in the indirect direction about the axis (OY) in order to lock said device.

It should be noted that although the manual actuator 3 described herein is capable of being rotated, said manual actuator could also be a linear actuator capable of moving in translation, without limiting the scope of the invention.

1. Device for manual emergency control of a remote system, said device comprising:
a body;
a manual actuator;
a system for transmitting a movement of the manual actuator to the remote system and;
a safety element limiting the possibilities for an operator to actuate said manual actuator;
said device being characterized in that:
the manual actuator comprises a keeper;
the safety element is a latch capable of being rotated about a latch axis of said body and comprising a notch capable of interacting with the keeper.

2. Device according to claim 1, characterised in that the manual actuator comprises a lever and a handle secured to each other, the keeper being arranged on the lever close to the latch.

3. Device according to claim 1, characterised in that the latch comprises at least one tension spring, wherein a first end of said tension spring is attached to the body at a fastening point, and a second end of said tension spring, opposite the first end, is connected to the latch at an attachment point offset from the latch axis.

4. Device according to claim 1, characterised in that the latch comprises at least one gripping means allowing an operator to rotate said latch.

5. Device according to claim 1, characterised in that it further comprises at least one stop intended to block the rotation of the latch in a locking direction or in an unlocking direction of said device.

6. Device according to claim 1, characterised in that the transmission system comprises:
a hydraulic control block;
a piston rod connecting the manual actuator to said hydraulic control block and capable of being moved by movement of the manual actuator in order to act on said hydraulic control block.

7. Device according to claim 1, characterised in that the body comprises two lateral flanges made integral with one another by a set of spacers.

8. An assembly of the device of claim 1 characterized in that the remote system is a hook for releasing a load suspended from a sling.

9. Assembly comprising an aircraft and a device for manual emergency control of a remote system according to claim 1, said device being fixed to a structure of the aircraft.

10. The assembly according to claim 9, characterised in that the aircraft is a helicopter.
